(19) United States
(12) Patent Application Publication
(10) Pub. No.: US 2012/0152505 A1
(43) Pub. Date: Jun. 21, 2012

(54) STRUCTURAL PLATE FOR AN AIR HANDLER SYSTEM

(75) Inventors: Colby Logan, Grenada, MS (US); Michael Denley, Calhoun City, MS (US)

(73) Assignee: Advanced Distributor Products LLC, Grenada, MS (US)

(21) Appl. No.: 12/973,419

(22) Filed: Dec. 20, 2010

(51) Int. Cl. F28F 9/22; B23P 17/00; F15D 1/00

(52) U.S. Cl. 165/159; 137/343; 29/890.09

(57) ABSTRACT

A structural plate for an air handler system. The system comprises a single sheet having at least two of the following structural elements: a) an air baffle for a heat exchanger; b) a stabilizer bracket attachable to an air handler cabinet; c) an air handler control box bracket; or d) a filter holder.

### TECHNICAL FIELD

This application is directed, in general, to air handlers, and methods of manufacturing thereof.

### BACKGROUND

The indoor unit of an air conditioning system, which often is referred to as an air handler system, typically includes multiple structural elements that are located in a common cabinet. The fabrication and assembly of multiple structural elements adds to the cost of the air handler system.

### SUMMARY

One embodiment of the present disclosure is a structural plate for an air handler system. The system comprises a single sheet having at least two of the following structural elements: a) an air baffle for a heat exchanger; b) a stabilizer bracket attachable to an air handler cabinet; c) an air handler control box bracket; or d) a filter holder.

Another embodiment of the present disclosure is an air handler system, comprising a cabinet a structural plate configured to be held in the cabinet. The structural plate includes the above-described single sheet.

Another embodiment of the present disclosure is a method of manufacturing a structural plate of an air handler system. The method includes providing a single sheet and forming outline portions in the single sheet for at least two of the above-described structural elements.

### BRIEF DESCRIPTION OF THE DRAWINGS

Reference is now made to the following descriptions taken in conjunction with the accompanying drawings, in which:

FIG. 1 presents perspective front view of an example structural plate of the disclosure;

FIG. 2A presents a front view of the example structural plate depicted in FIG. 1;

FIG. 2B presents a side view of the example structural plate depicted in FIG. 1;

FIG. 2C presents a plane view of the example structural plate depicted in FIG. 1;

FIG. 3 presents a perspective front view of an example air handler system of the disclosure, including an example structural plate, such as depicted in FIGS. 1-2C;

FIG. 4 presents a flow diagram of an example method of manufacturing structural plate of the disclosure, such as any of the plates discussed in the context of FIGS. 1-3; and

FIG. 5 presents plan view of an example structural plate of the disclosure at an intermediate stage of manufacture such as an intermediate stage of the example method presented in FIG. 4.

### DETAILED DESCRIPTION

Embodiments of the present disclosure benefit from the discovery that the efficient manufacture and assembly of an air handler system benefit from the use of a structural plate that can provide multiple structural elements which hitherto were provided for via multiple separate parts. For instance, the structural plate of the disclosure reduces the cost of the disclosed air handler system by reducing the number of the system's parts that need to be manufactured, shipped and assembled.

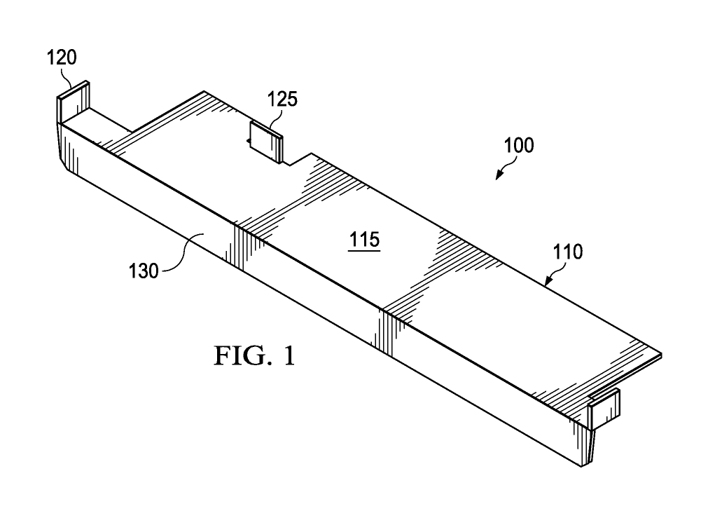

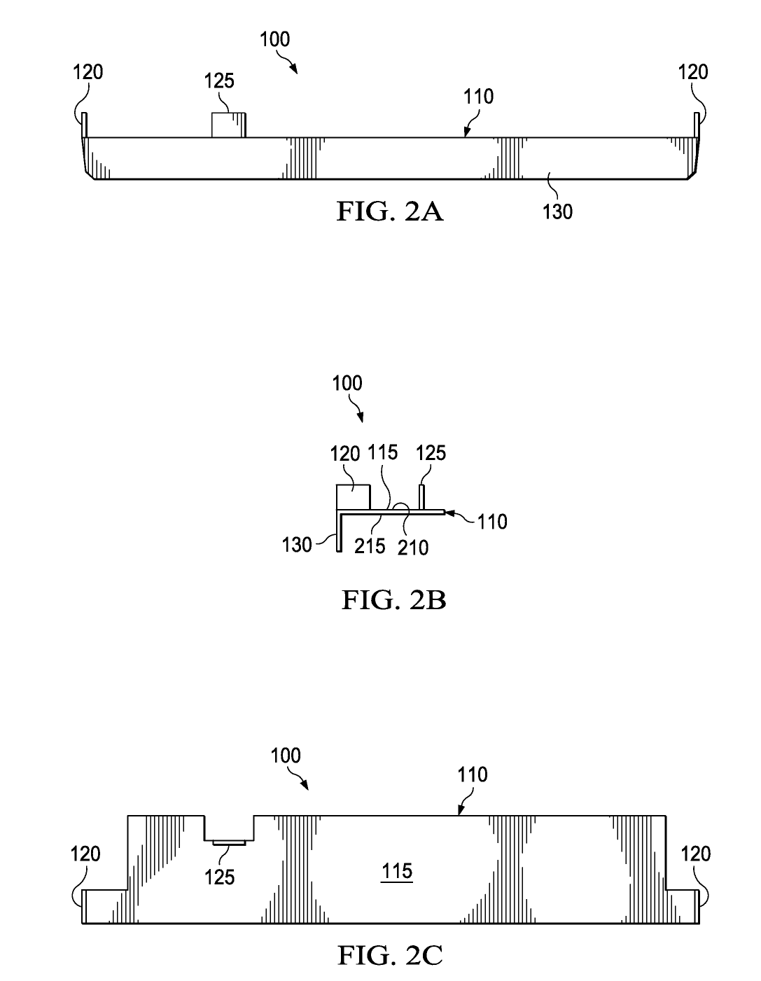

One embodiment of the present disclosure is a structural plate for an air handler system. FIG. 1 presents a perspective front view of an example structural plate 100 of the disclosure. FIG. 2A presents a front view of the example structural plate 100 depicted in FIG. 1. FIG. 2B presents a side view of the example structural plate depicted in FIG. 1. FIG. 2C presents a plane view of the example structural plate depicted in FIG. 1

With continuing reference to FIGS. 1-2C, the plate 100 comprises a single sheet 110 having at least two of the following structural elements: a) an air baffle 115 for a heat exchanger; b) a stabilizer bracket 120 attachable to an air handler cabinet; c) an air handler control box bracket 125; or d) a filter holder 130.

The term single sheet as used herein refers to a unitary body of material. In some embodiments, the single sheet 110 can be a metal sheet, such as a steel sheet, but in other embodiments, the single sheet 110 can be made of other materials such as a ceramic material, plastic material or other materials well known to those skilled in the art.

Some embodiments of the plate 100 include any two of these structural elements. For example, the plate 100 can include the air baffle 115 and anyone of the stabilizer bracket 120, the control box bracket 125 or the filter holder 130. Or, the plate 100 can include the stabilizer bracket 120 and anyone of the control box bracket 125 or the filter holder 130. Or, the plate 100 can include the control box bracket 125 and the filter holder 130.

Some embodiments of the plate 100 include any third of these structural elements. For example, the plate 100 can include the air baffle 115, the stabilizer bracket 120 and control box bracket 125. Or, the plate 100 can include and the air baffle 115, the stabilizer bracket 120 and the filter holder 130. Or, the plate 100 can include air baffle 115, the control box bracket 125 and the filter holder 130. Or the plate 100, can include the stabilizer bracket 120, the control box bracket 125 and the filter holder 130.

Some embodiments of the plate 100 include all four of the structural elements: the air baffle 115, the stabilizer bracket 120, the control box bracket 125 and the filter holder 130.

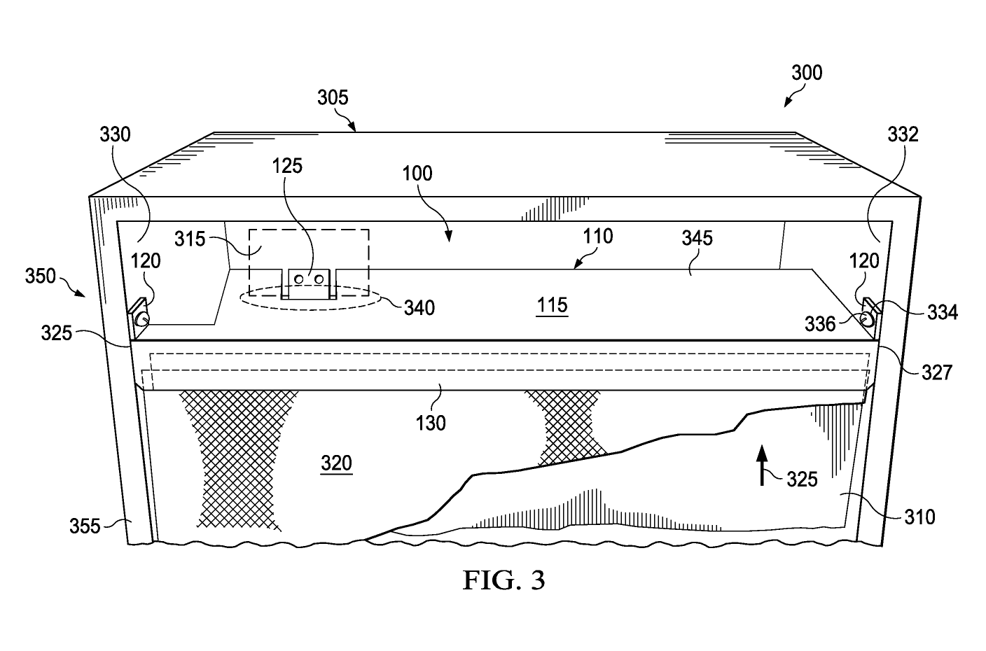

Another embodiment of the disclosure is air handler system FIG. 3 presents a perspective front view of an example air handler system 300 of the disclosure, including an example structural plate 100, such as depicted in FIGS. 1-2C. Any of the embodiments of the plate 100 described in the context of FIGS. 1-2C could be part of the system 300.

As illustrated in FIG. 3, the air handler system 300 comprises an air handler cabinet 305 and a structural plate 100 configured to be held in the cabinet 305. The structural plate 100 includes a single sheet 110 having at least two of the following structural elements: a) an air baffle 115 for a heat exchanger 310 of the system 300; b) a stabilizer bracket 120 attachable to the cabinet 305; c) a bracket 125 for an air handler control box 315; or d) a holder 130 for a filter 320.

In some embodiments of the system 300, the single sheet 110 is configured to be positioned directly above a location in the cabinet 310 for the heat exchanger 310 such that the air baffle structural element 115 would block vertical air flow 325 from the heat exchanger 310 when the system 300 is operating.

In some embodiments of the system 300, the single sheet 110 is configured such that one or more ends 325, 327 of the single sheet 110 having the stabilizer bracket structural element 120 are attachable to one or more walls 330, 332 of the cabinet 305. For example, in some embodiments of the 110, as depicted in FIG. 3, two stabilizer brackets 120 are located on opposite ends 325, 327 of the single sheet 110 and the ends 325, 327 are each attachable to one or two opposing walls 330, 332 of the cabinet 305. The brackets 120 can have openings 334 (e.g., circular holes or slots) to facilitate attachment to the walls 330, 332 or other parts of the cabinet 305, via attachment structures 336 such as, nuts and bolts, screws, rivets, welds, glue or other attachment means well known to those skilled in the art. The stabilizer brackets 120 thereby facilitate the sheet 110 to serve as a tie bar, which can beneficially prevent the cabinet 305 from rocking, shifting, or swaying from side to side, e.g., during the servicing, installation, or operation of the air handler system 300.

In some embodiments of the system 300, a portion 340 of a surface 345 the air baffle structural element 115 is a mounting location for the control box 315, wherein the surface 345 is not directly exposed to the air flow 325 from the heat exchanger 310 when the system 300 is operating. For example, when a bottom surface 210 (FIG. 2B) of the air baffle structural element 115 blocks the air flow 325 from the heat exchanger 310, e.g., located below the single sheet 110, then a portion 340 of the top surface 215 of the air baffle structural element 115, that is not directly exposed to the air flow 325, and can be used as the mounting location. In other cases, however, the control box 315 can be mounted to the control box bracket 125 such that it does not touch any other portion of the single sheet 110, including any of the other structural elements 115, 120, 130.

In some embodiments of the system 300, the single sheet 110 is configured to be located at the front side 350 of the cabinet 305 such that when the filter 320 (e.g., a particle filter) is held in place by the filter holder structural element 130, the filter 320 is substantial flush with the outer surface 355 of the front side 350 of the cabinet 305.

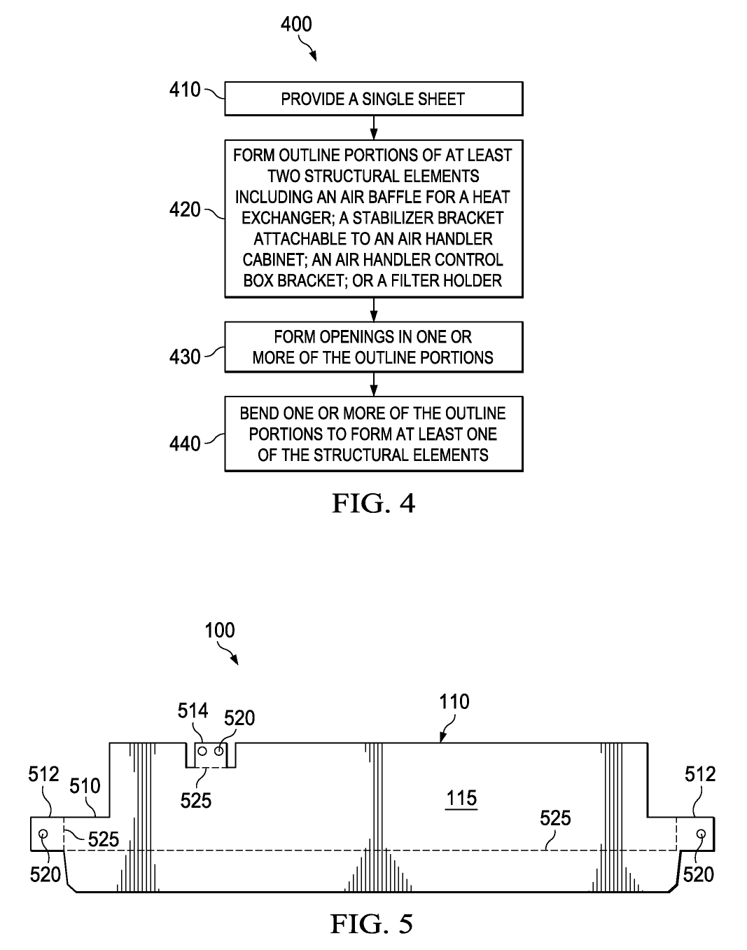

Another embodiment of the present disclosure is a method of manufacturing a structural plate of an air handler system. FIG. 4 presents a flow diagram of an example method 400 manufacture. The method 400 can be used to manufacture any of the plates 100 discussed in the context of FIGS. 1-3. FIG. 5 presents an example structural plate 100 of the disclosure at an intermediate stage of manufacture, such an intermediate stage of the example method presented in FIG. 4.

With continuing reference to FIGS. 1-3 and 5 throughout, the example method 400 depicted in FIG. 4 comprises a step 410 of providing a single sheet 110 (e.g., a metal, ceramic, plastic or other material having a rectangular or square planar shape), and, a step 420 of forming outline portions 510, 512, 514, 516 of least two of the above-described structural elements 115, 120, 125, 130, respectively.

In some embodiments of the method 400, forming the outline portions 510, 512, 514, 516 in step 420 includes placing the sheet 110 (e.g., a metal sheet) into a turret-press machine that is configured to cut the sheet 110. In other cases, however, one or more of the outline portions 510, 512, 514, 516 can be alternatively formed in step 420 by placing the sheet 110 in a stamping, molding or other cutting or machining tool (e.g., a computer numerical controlled machine tool) configured to form the outline portions 510, 512, 514, 516.

Some embodiments of the method 400 further include a step 430 of forming one or more openings 520 in one or more of the outline portions 510, 512, 514, 516. For example, as depicted in FIG. 5, openings 520 can be formed in the outline portion 512 for the stabilizer bracket structural element 120 (FIG. 1) or in the outline portion 514 for the air handler control box bracket 125 (FIG. 1). Such openings 520 can, e.g., facilitate coupling the plate 100 to an air handler cabinet 305, or facilitate coupling a control box 315 to the plate 100.

Some embodiments of the method 400 further include a step 440 of bending one or more of the outline portions 510, 512, 514, 516 of the single sheet 110 to form at least one of the structural elements 115, 120, 125, 130. For example, the sheet 110 can be placed in a break-press machine which is configured to bend the sheet 110 along one or more 5 predefined bend lines 525. In other cases however, bending in step 440 may alternatively or additionally include manually bending one or more of the outline portions 510, 512, 514, 516 e.g., by an installer of an air handler system 300. For example, the outline portion 514 corresponding to the control box bracket 315 may be shipped to an installer who then manually bends one or more of the outline portions (e.g., portion 514), to form the control box bracket structural element 120 or other structural elements.

In some cases, bending the outlined portions in step 440 bending one outline portion (e.g., portion 516) of the single sheet in a first direction to form the filter holder structural element 130, and bending one or more other outline portions (e.g., portions 512 or 514 or both) in a second opposite direction to form one or both of the stabilizer bracket structural element 120 and the control box bracket structural element 125. In other cases, however, the outline portion 512 could be bent in the same direction as the outline portion 516 and the outline portion 514 is bent in the opposite direction 535. Based upon the disclosure herein one skilled in the art would appreciate that various other combinations of bending could be performed in step 440 as part of manufacturing the plate 100.

One of ordinary skill in the art would appreciate that the method of manufacture 400 could further include attaching other components or parts of an air handler system to the plate 100, or further processing steps to complete the manufacture of the plate 100.

Those skilled in the art to which this application relates will appreciate that other and further additions, deletions, substitutions and modifications may be made to the described embodiments.

What is claimed is:

1. A structural plate for an air handler system, comprising:
a single sheet having at least two of the following structural elements:
a) an air baffle for a heat exchanger;
b) a stabilizer bracket attachable to an air handler cabinet;
c) an air handler control box bracket; or
d) a filter holder.

2. The structural plate of claim 1, wherein the single sheet has the structural elements (a) and (b).

3. The structural plate of claim 1, wherein the single sheet has the structural elements (a) and (c).

4. The structural plate of claim 1, wherein the single sheet has the structural elements (a) and (d).

5. The structural plate of claim 1, wherein the single sheet has the structural elements (b) and (c).

6. The structural plate of claim 1, wherein the single sheet has the structural elements (b) and (d).

7. The structural plate of claim 1, wherein the single sheet has the structural elements (c) and (d).

8. The structural plate of claim 1, wherein the single sheet has the structural elements (a), (b) and (c).

9. The structural plate of claim 1, wherein the single sheet has the structural elements (a), (b) and (d).

10. The structural plate of claim 1, wherein the single sheet has the structural elements (a), (c) and (d).

11. The structural plate of claim 1, wherein the single sheet has the structural elements (b), (c) and (d).

12. The structural plate of claim 1, wherein the single sheet has the structural elements (a), (b), (c) and (d).

13. An air handler system, comprising:
an cabinet; and
a structural plate configured to be held in the cabinet, the structural plate including:
a single sheet having at least two of the following structural elements:
a) an air baffle for a heat exchanger of the system;
b) a stabilizer bracket attachable to the cabinet;
c) an air handler control box bracket; or
d) a filter holder.

14. The system of claim 13, wherein the single sheet is configured to be positioned directly above a location in the cabinet for the heat exchanger such that the air baffle structural element would block vertical air flow from the heat exchanger when the system is operating.

15. The system of claim 13, wherein the single sheet is configured such that one or more ends of the single sheet having the stabilizer bracket structural element are attachable to one or more walls of the cabinet.

16. The system of claim 13, wherein a portion of a surface the air baffle structural element is a mounting location for an air handler control box, wherein the surface is not directly exposed to air flow from the heat exchanger when the system is operating.

17. The system of claim 13, wherein the single sheet is configured to be located at the front side of the cabinet such that when a filter held in place by the filter holder structural element, the filter is substantial flush with the outer surface of the front side of the cabinet.

18. A method of manufacturing a structural plate for an air handler system, comprising:
providing a single sheet; and
forming outline portions in the single sheet for at least two of the following structural elements:
a) an air baffle for a heat exchanger;
b) a stabilizer bracket attachable to an air handler cabinet;
c) an air handler control box bracket; or
d) a filter holder.

19. The method of claim 18, wherein forming the outline portions includes placing the sheet into a turret-press machine configured to cut the sheet.

20. The method of claim 18, further including bending one or more of the outline portions of the single sheet to form at least one of the structural elements.
